(19) United States
(12) Patent Application Publication
(10) Pub. No.: US 2009/0133260 A1
(43) Pub. Date: May 28, 2009

(54) 3D dental shade matching and apparatus

(75) Inventors: Duane Milford Durbin, San Diego, CA (US); Dennis Arthur Durbin, Solana Beach, CA (US); Marty J. Dymek, Long Beach, CA (US); Laurence Warden, Poway, CA (US)

Correspondence Address: Duane Durbin, 7660 Norcanyon Way, San Diego, CA, 92126, US

(73) Assignee: IOS Technologies, Inc

(21) Appl. No.: 11/986,642

(22) Filed: Nov. 26, 2007

(51) Int. Cl. A61C 7/02

(52) U.S. Cl. 29/896.11

(57) ABSTRACT

Systems and methods are disclosed to fabricate a restorative prosthesis. The system includes a scanner to intra orally capture color and translucency information along with a three dimensional (3D) shape of the dentition being reconstructed. The system also includes a computer aided design (CAD) module to receive the color and translucency information and the 3D shape to render a color accurate representation of the prosthesis for review, wherein the color, translucency and surface information is combined in a single digital prescription which is electronically transferred to a laboratory or CAD/CAM system for fabrication. The system provides the capability for 3D shape, color and translucency characteristics of the final prosthesis to be measured and quantitatively compared to the prescribed requirements.

This invention relates to capturing and transferring of information to a dental laboratory and/or CAD/CAM (Computer Aided Design/Computer Aided Manufacturing) system to fabricate and achieve an optimal restorative prosthesis.

### BACKGROUND

In recent years there has been increasing demand for aesthetic dental treatment using dental prosthesis. This has created a need for tools capable of providing precise color and translucency information about patients' teeth. Restorative dentistry, the practice of replacement of all or part of a patient's teeth, involves not only the structural and shape characteristics of the tooth being replaced and the preparation area of a tooth or teeth but also the aesthetic characteristics of tooth color and translucency to achieve a successful result. Guided by specific visual observational information typically provided by the dentist, the lab utilizes certain materials, construction techniques, tints and dyes to recreate a natural looking restorative piece to closely match the surrounding teeth. Traditionally, the dentist uses color samples or charts provided by the restorative material manufacturers to specify the shade or shades to be used in the restoration. However, due to the complex construction of a human tooth, a single color chip or shade typically cannot accurately describe a tooth adequately for a natural looking reconstruction. Teeth are often stratified with different colors, with the surface near the gums typically a darker color than the occlusal end. Additionally, translucency also changes across the tooth, typically becoming more translucent at the occlusal surface than nearer the gums. Therefore, multiple shades and information on translucency at different areas are required to adequately communicate the desired result to the lab or aid the dentist in preparation of direct restoration materials used in the dental office. Traditionally, dentists and dental technicians have obtained tooth color information through visual examinations using color samples known as “shade guides” that often come in a shade guide kit comprised of several shades spanning a range of expected tooth colors. However, when using shade guides, dentists and dental technicians typically are observing the teeth and prosthesis under different light sources In addition, it is common for the natural tooth to appear to be a shade that is not a good match with a specific shade guide but rather the natural tooth shade lies between the 2 closest shades guides in a shade guide kit. This results in discrepancies in the subjective judgments about tooth shade information which in turn leads to errors in the manufacture of prosthesis for patients. With the current shade guide method, the shade information cannot be consistently conveyed accurately to the lab technicians who produce the prosthesis. Shade mismatching between prosthesis and patients' teeth frequently necessitates the remaking of a prosthesis.

Limitations in accurately determining the shade characteristics of teeth by means of visual matching are affected by; 1) ambient room lighting, 2) reflective elements and colors within the room, 3) subjective level of color perception of the dentist or technician, 4) visual fatigue, 5) ability to convey shade changes across the dentition accurately to the lab, 6) the graduated levels of shades in a typical shade guide kit. In some restorative cases, particularly with incisors and canine teeth, it is sometimes necessary for the patient to visit the lab performing the reconstruction, allowing the technician to perform the shade matching him or herself directly with the patient. In cases where the restoration is done without the lab technician performing the color matching directly, a detailed description of the shade transitions must be conveyed from the dentist to the lab via the prescription form. This places an additional burden on the dentist and lab technician and introduces several areas for potential human error.

For a direct restoration, for example when the dentist is using a composite material to fill a void in a tooth, the dentist typically selects the final shade through a trial and error process by making an initial guess using color charts, then mixing, curing and verifying the trial mix directly against the patient's teeth. Once a trial mix is found to be an acceptable match, the dentist mixes up a replicate batch and uses this as the material to create the direct restoration.

Recently, several devices have been developed and introduced to the market which can subjectively quantify the aspects of tooth color. The devices are split into two basic types of measurement modalities: 1) camera based devices and 2) spectrometer devices. The camera based devices (ShadeScan™—Cynovad Inc., ClearMatch™—Clarity Dental Corp.) consist of a low cost color camera and software to determine the color components for a given area of dentition. These devices determine color using a simple mosaic RGB filter on the camera sensor chip to quantify the level of each color component. Spectrometer based devices (ShadeEye™—Shofu Inc. ShadeVision™—X-Rite Inc.) split the light from the area being measured into its color components utilizing a diffractive element and measure the light spectrum using a linear sensor. A spectrometer based measurement is generally capable of giving a more accurate representation of the color components. Since the spectrophotometer is not truly an imaging device it relies on the operator to locate the area being sampled manually and can therefore be prone to positional errors. Camera based devices, while less accurate in their determination of color can provide a better indication of changes in color or shade in relation to the surface geometry of the tooth itself. A third type of hybrid device (SpectroShade™—MHT Optics Research AG, Crystaleye™—Olympus) uses a black and white imaging sensor and controllable multi-spectral light source to illuminate the teeth at different wavelengths. Computer analysis of a set of images taken at several wavelengths of illumination determines the spectral components of the entire tooth.

Each of the existing systems described above typically define colors in terms of Munsell parameters, (hue, value, chroma). Most systems contain color lookup libraries provided by material manufacturers to aid in material selection. Studies have shown that the use of these devices, (particularly the spectrometer-based devices) can significantly improve the accuracy of restorations over the visual color matched approach (Visual and Spectrophotometric Shade Analysis of Human Teeth, S. Paul, A. Peter, N. Pietrobon, and C. H. F. Hämmerle, J Dent Res 81(8): 578-582, 2002). However, none of the existing systems can quantify translucency of the teeth and can therefore not accurately convey all of the necessary aesthetic information needed for a restoration. In addition, the color information obtained by currently available devices is not incorporated directly into the 3D model of the teeth created from a digital impression.

### SUMMARY

Systems and methods are disclosed to fabricate a restorative prosthesis. The system includes a scanner to intra orally capture color and translucency information along with a three dimensional (3D) shape of the dentition being reconstructed. The system also includes a computer aided design (CAD) module to receive the color and translucency information and the 3D shape to render a color accurate virtual model representation of the prosthesis for review, wherein the color, translucency and surface information is combined in a single digital prescription which is electronically transferred to a laboratory or CAD/CAM system for fabrication. The capability for the 3D shape, color and translucency characteristics of the final prosthesis to be measured and quantitatively compared to the prescribed requirements is another aspect of this invention.

Advantages of the system may include one or more of the following. The preferred embodiment reduces the most significant sources of error in restorative dentistry including: 1) a poor fit of the prosthetic on the prepared area; 2) errors in color matching to the surrounding teeth; and 3) errors in the appearance of translucency in the restored tooth. The preferred embodiment combines the measurement of translucency and color characteristics information of the dentition along with a highly accurate three dimensional surface measurement of the preparation area. The result is a complete set of data required for a restoration with optimal fit and aesthetics. Software can then automatically select an optimal material for the restoration based on a stored library of color and translucency characteristics of restorative materials. The system allows determination of subtle shade differences to be done quickly. In addition, the preferred embodiment includes a system to graphically represent the existing teeth along with a rendering of the proposed restoration, complete with color and translucency characteristics which can be reviewed by the dentist, technician and patient. Moreover, because color information can be fully and quantitatively described on laboratory instruction forms, it is easy to share precise color information between the dental office and the laboratory or the dental office and a CAD/CAM system. The system is simple and easy to use, and the dentist (or technician) can capture accurate shade and translucency data without the need for additional devices. The software forwards the information electronically to the laboratory, allowing the technician to determine the shape and shade of the tooth and make detailed color analyses of the location requiring examination. The ability to integrate all or some of this information into a digital prescription and electronically transmit the data between the dentist and the dental laboratory or the dentist and a CAD/CAM system allows rapid and accurate communication in specifying and manufacturing the prosthesis. Further, a version of the system configured for use by a dental technician can be located at the dental laboratory to quantitatively measure the 3D shape, color, and translucency characteristics of the final prosthesis providing a means to perform a quality assurance check of the prosthesis before it is shipped to the customer and fitted to the patient.

### BRIEF DESCRIPTION OF THE DRAWINGS

FIG. 1A shows an exemplary system to capture the information needed to generate a digital prescription for a color-matched restorative prosthesis.

FIG. 1B shows an exemplary system used to perform a quality control (QC) check on a final prosthesis.

FIG. 1C shows an exemplary process for capturing and transferring to a laboratory of information to achieve an optimal restoration of prosthesis.

FIG. 2 is a block diagram illustrating an exemplary environment for viewing, altering, and archiving digital models of dental structures, including dentition color and translucency information, and for supporting computer integrated manufacturing of physical models of the dental structures using the digital model files.

FIG. 3 shows a system and method for previewing digital dental models and performing treatment planning.

FIG. 4 shows an exemplary process for capturing the 3D shape, color, and translucency characteristics of a finished prosthesis and comparing the data representing those characteristics with the prescribed data provided by the dentist as a QC check before the prosthesis is fit on the patient.

### DESCRIPTION

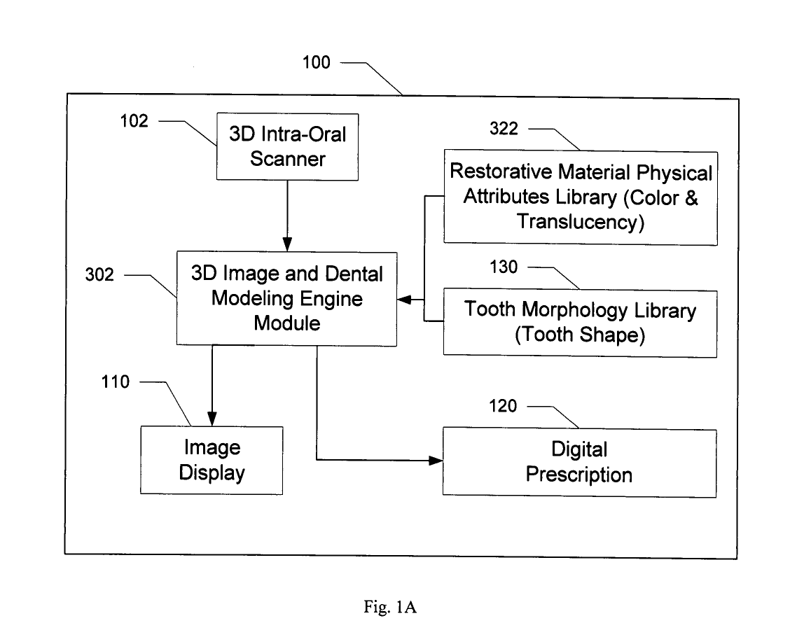

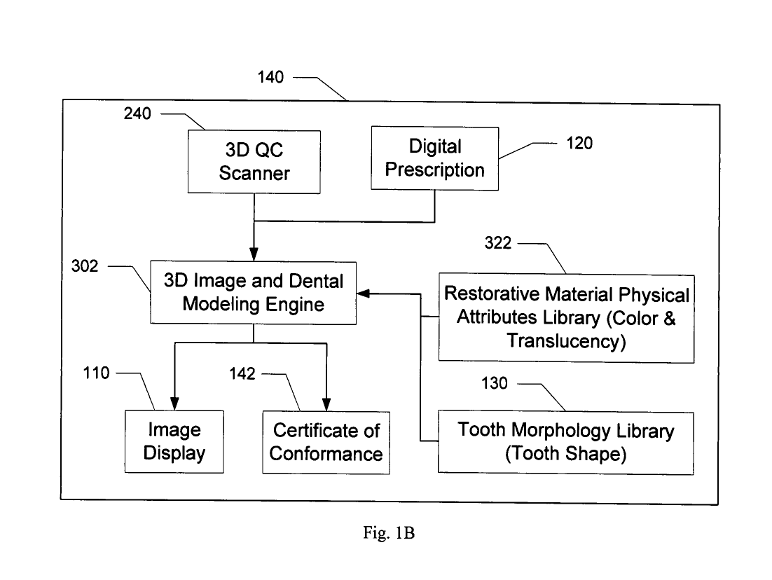

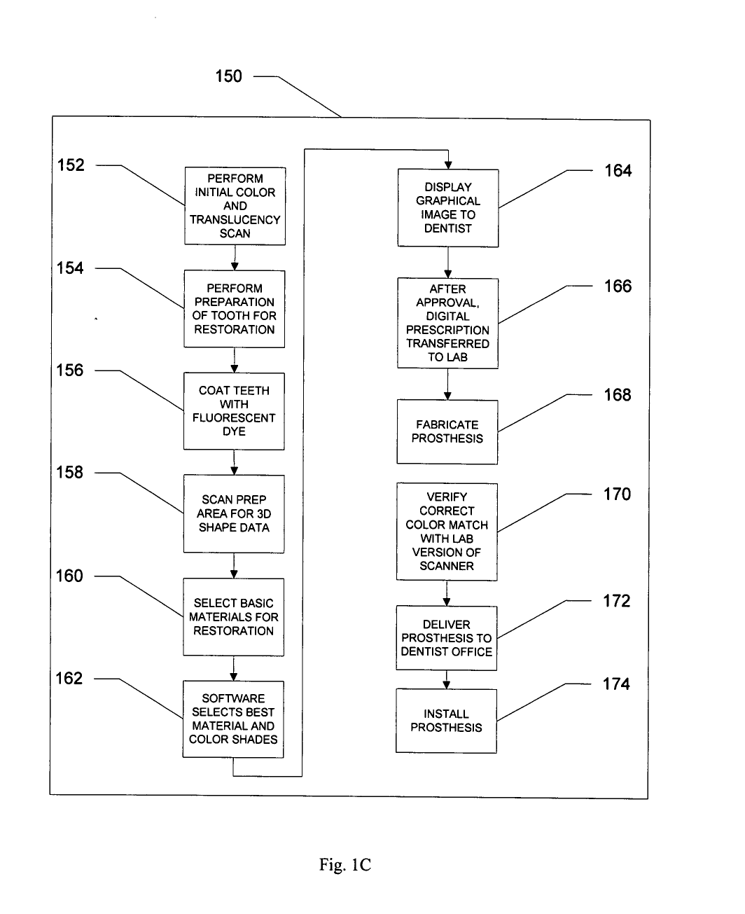

FIG. 1A shows an exemplary dental imaging system 100 to capture, review and approve the necessary 3D information required to fabricate a high-quality color-matched restorative prosthesis.

The data generated by the 3D intra-oral scanner 102 is provided to a 3D image and dental modeling engine module 302 that receives the color and translucency information from a restorative material physical attributes library 322 and renders the 3D shape of the dentition of be restored based upon data from the tooth morphology library 130 or alternately from a 3D scan of the patient's dentition before the tooth preparation, to give an accurate color representation of the candidate prosthesis and adjacent dentition. This lifelike rendering is displayed for review on an image display 110 for approval by a treating professional such as a dentist, or for consulting with the patient. Once the 3D model of a prosthesis design is approved, the 3D image and dental modeling engine module 302 then combines the color, translucency and surface information into a single digital prescription 120 which is electronically transferred to a laboratory or CAD/CAM system for fabrication of the physical prosthesis.

The tooth morphology library 130 is a digital database comprised of 3D models of individual teeth that collectively cover the general morphology of human teeth, from first molar to central incisor. The tooth morphology library 130 can be customized by the user by adding tooth shapes to the library or by altering the default shape of a particular tooth type. Further, the tooth morphology library 130 can be patient specific where the tooth model for each of the patient's teeth is captured by taking a 3D scan of the patient's entire dentition during for example, a routine office visit, and then storing the scan data in the patient's personalized tooth library. Subsequently, when a tooth restoration is necessary for that patient, the patient's personalized tooth model library may be accessed to obtain the patient specific tooth model to be used as the pattern to construct the patient's prosthesis.

FIG. 1B shows an exemplary Prosthesis QC system 140 for use in the quality control of dental prosthesis. Data from the electronically transferred digital prescription 120 is loaded into the 3D image and dental modeling engine 302. The completed prosthesis is imaged with a 3D QC scanner 240, which is similar in imaging functionality to the intra-oral scanner 102 but is physically configured specifically for capturing the 3D shape, color and translucency characteristics of a finished prosthesis. Material physical properties from the restorative material physical attributes library 322 and tooth morphology from the tooth morphology library 130 are also accessed by the 3D image and dental modeling engine 302 as needed to construct a virtual 3D model of the prescribed prosthesis. The prosthesis surface data captured from the 3D QC scanner 240 is compared against the data from the digital prescription 120 whereby a virtual fit check is performed between the prosthesis and preparation surface data contained in the digital prescription 120. Configurable limits of acceptance are contained within the 3D image and dental modeling engine 302 with respect to fit tolerances, color match, and translucency match. Color and translucency data captured by the 3D QC scanner 240 are also compared against data captured from the patient and contained within the digital prescription 120. The image display 110 shows a 3D representation of the finished prosthesis as measured and the results of an analysis of fit, color and translucency with respect to the prescription 120. If within predefined limits of acceptance, a certificate of conformance 142 can be printed thereby providing a record of objective analysis of the final product vs. the prescription. Measured characteristics out of acceptable limits are indicated to the operator allowing the restorative part to be reworked or remade if necessary to bring the prosthesis within acceptable limits.

FIG. 1C shows an exemplary process 150 for manufacturing an optimal restorative prosthesis based on the digital prescription information captured using the dental imaging system 100 and quality control checked using the prosthesis QC system 140. First, the process performs an initial intra oral color measurement and translucency scan (step 152). Next, the dentist prepares a tooth for restoration (step 154). The prepared tooth is then coated with a fluorescent dye (step 156). The prepared area is then scanned to capture 3D shape data at the treating location (step 158) using the 3D intra-oral scanner 102. The operator then selects basic materials for performing the restoration (step 160). The dental imaging system 100 then selects or suggests the best material and color shade for the prosthesis (step 162). The dental imaging system 100 displays a graphical image of the prosthesis on the image display 110 to the operator or treating professional (step 164). The treating professional approves the design, and a prescription is electronically sent by the dental imaging system 100 to a laboratory or CAD/CAM facility (step 166). The prosthesis is fabricated (step 168), and a lab technician verifies the color match, translucency, and 3D shape with a prosthesis QC system 140 located at the lab or CAD/CAM facility (step 170). After the prosthesis is verified to match the prescription, the prosthesis is delivered to the treating office such as the dentist office (step 172). The treating professional then installs the prosthesis (step 174).

The fluorescent-based coating used at step 156 can be the coating described in U.S. Pat. No. 6,592,371 titled Method and System for Imaging and Modeling A Three Dimensional Structure by Durbin et al, the content of which is incorporated herein.

The above embodiment integrates color and translucency information along with the three dimensional shape of the dentition being reconstructed. The color, translucency and surface information is combined in a single digital prescription which can be electronically transferred to the lab. Within this prescription the three dimensional aspects of the prepared area of a prepared tooth, as well as additional three dimensional information of adjacent or occlusal teeth and/or bite information are characterized. In addition, a representation of the shape of the tooth before it was prepared or a representation of the final exterior surface through CAD software can also be included if the treating professional such as a dentist chooses to design the restoration. Detailed description of the 3D structure of the tooth, capture, manipulation and transfer are described in U.S. Pat. Nos. 6,364,660B1 and 6,592,371B2 and are incorporated by reference herein as a “Digital Impression”. U.S. Pat. Nos. 6,364,660B1 and 6,592,371B2 Method and System for Imaging And Modeling Dental Structures and Method and System for Imaging A Three Dimensional Structure teach a methodology and apparatus to allow for rapid intra oral images to be taken of dental structures in such a way, and with sufficient resolution such that the acquired images can be processed into accurate 3D models of the imaged dental structures. The images and models have application in dental diagnosis and for the specification and manufacture of dental prosthetics such as bridgeworks, crowns or other precision moldings and fabrications. The embodiment of FIG. 1A, FIG. 1B, and FIG. 1C broadens the use of the Digital Impression system to include aesthetic information (color and translucency) about the teeth to aid in manufacturing of restorative appliances or in direct restorations. The 3D information can be combined with the needed aesthetic information to provide a complete and integrated digital prescription to the dental lab. As such, the embodiment includes color and translucency information along with the 3D shape data.

In one embodiment, the Digital Impression device can capture the aspects of color by one of the aforementioned approaches, camera, spectrophotometer, or a hybrid combination thereof. The device for capturing this spectral information can be integrated into the intra-oral scanner portion of the Digital Impression device, or may be a separate handheld device integrated with the Digital Impression system.

The embodiment of FIG. 1A provides the ability to quantify the translucency of the teeth three dimensionally. The description of the intra-oral scanner as described by Digital Impression system is modified to capture information on the translucency and light scattering properties of the teeth being measured. In an operating mode to capture 3D shape, the intra-oral scanner of the Digital Impression system uses a fluorescent coating on the teeth in conjunction with a long-wavelength high-pass cutoff filter in the path of the detection optics to discriminate between unwanted scatter of the illumination beam within the semi-transparent tooth structure and the true surface represented by the fluorescent signal from the coated tooth. If the long pass filter is removed and the fluorescent coating is not used, the illumination line will penetrate and be scattered within the tooth structure. In a preferred method, this aesthetic mode scan would be performed before the preparation of the tooth. The amount of scattering and the resultant line characteristics are quantified to determine the level of translucency in the region of the surface of the tooth being scanned. For example, teeth surfaces with higher translucency would result in a softer and broader line profile as the light from the illumination line will penetrate further into the tooth and be scattered while other tooth surfaces which are more opaque would result in sharper line profiles due to less penetration and scattering. The correlation between line width and translucency can be characterized in advance and may be stored as a function within the system software. Since the scanner device scans across the teeth surfaces, the translucency data can be collected for the entire surface of the tooth or multiple teeth and can be correlated with the three dimensional surface structure to give a 3D representation of the translucency.

In one embodiment, the system software includes a database of common restorative materials from one or more manufacturers that would include construction methodologies with fully characterized color and translucency characteristics for each material. In the preferred embodiment, the software contains an algorithm to automatically select the best combination of restorative materials considering the patient's esthetic goals and budget. This selection of restorative materials could be partially guided by the dentist through a list of parameters or may be performed totally automatically. For direct restorations, the dentist would use the system to take an initial color and translucency measurement on the tooth before its prepared or on a neighboring tooth. The software would then select the best matching material or materials based on the library of properties. The dentist would typically then mix a sample of the suggested materials, cure the material, and then check using the dental imaging system 100 to verify the proper shade and translucency match was achieved before applying on the patient.

In one embodiment that combines the color and translucency information with the three dimensional shape information, the digital prescription containing both the 3D model of the preparation area and the color and translucency information provides the dental laboratory accurate and quantitative data upon which to construct the restoration thereby reducing errors and remakes by eliminating inaccurate manual and subjective processes. The combined data set allows for semi-automated or automated selection of materials, thicknesses, colors and tints for a restoration based on the material library 322.

In one embodiment, using realistic software rendering and ray tracing, a lifelike computer model of the restoration can be developed including the optical properties of the different candidate material compositions, types and shades. The final rendered model can be viewed and rotated on the display screen and lit with simulated light sources to view the 3D model of the virtual restoration under different lighting conditions. When shared with the patient, the simulation could be used to represent various approaches to treatment and may help the patient to select the best approach to match their budget and aesthetic needs.

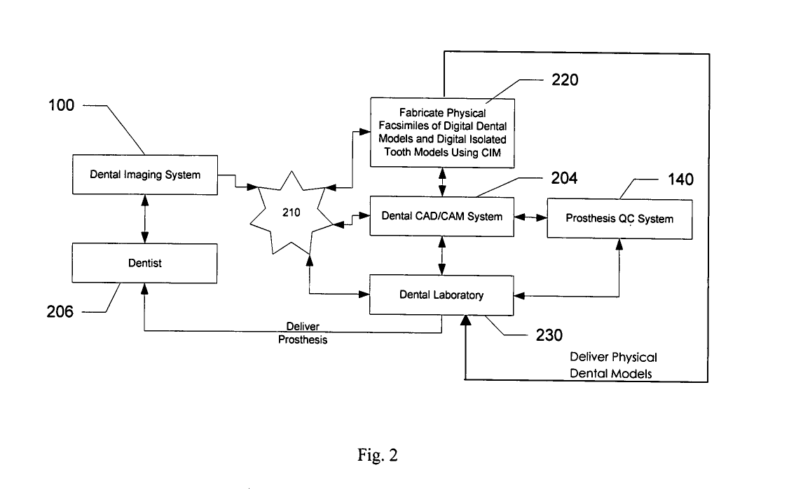

FIG. 2 is a block diagram that illustrates an exemplary environment for capturing, viewing, altering, archiving digital models of dental structures, including color and translucency of the structures, and supporting computer integrated manufacturing of physical models of the dental structures using the digital model files. In the environment of FIG. 2, data obtained by the dental imaging system 100 of the dental structures is used to create a 3D digital dental model representative of the surface contour of the scanned dental structures. Descriptions of the method and apparatus to obtain this digital dental model are described in U.S. Pat. No. 6,364,660, the contents of which are incorporated by reference herein.

The data representing the digital dental model from the dental imaging system 100 is transferred over a wide area network 210 such as the Internet to a dental laboratory facility 230 with computer aided design (CAD) and/or computer aided manufacturing (CAM) capabilities. Using the Dental CAD/CAM System 204 a dental laboratory technician may view the digital dental model and select those teeth for which a tooth die model is desired. The Dental CAD/CAM System 204 would then create 3D digital isolated tooth die models of the selected teeth. The technician could then select which of the digital models should be fabricated into a physical model utilizing Computer Integrated Manufacturing (CIM) methods 220 and technologies such as Stereo Lithography Apparatus (SLA) or direct CAM. Typically, a CIM fabricated isolated tooth die model would be delivered to the dental laboratory 230 where the lab technician uses the physical model as a pattern to fabricate a prosthetic such as a crown or bridge. The prosthesis QC system 140 would be used to verify that the final prosthesis matched the digital prescription 120 sent from the dental imaging system 100. After verification, the finished prosthesis would then be shipped directly back to the dentist 206.

Following fabrication at either the dental CAD/CAM facility 204 or fabrication at the dental laboratory 230, finished prosthetic devices can be verified using the prosthesis QC system 140.

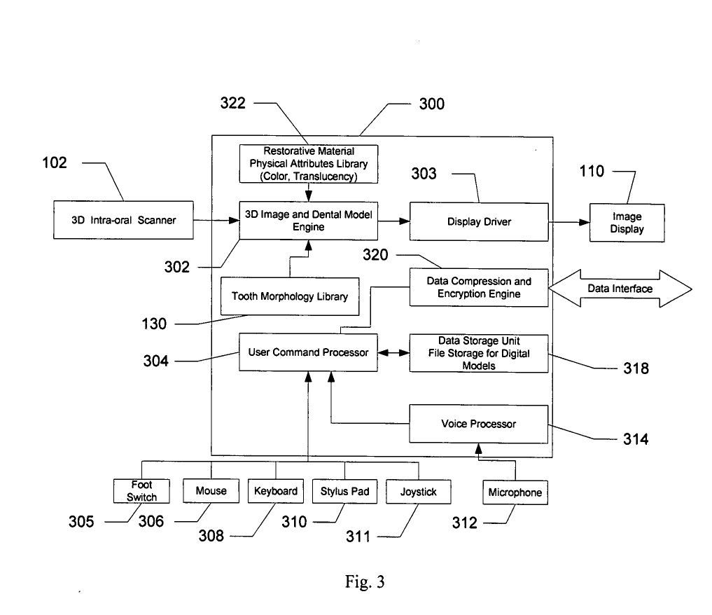

Referring now to FIG. 3, a dental CAD system 300 for viewing digital dental models and performing treatment planning is presented. Data from an intra-oral dental scanner 102 is processed by a 3D image and dental model engine 302 and displayed as a scaled 3D view of the dental structures. The 3D image and dental model engine 302 also assesses the quality of the acquired digital dental model and can display to the user highlighted regions where the digital dental model reflects an anomalous surface contour, or where uncertainties in the calculated estimate of the surface contour exceeds a user specified limit. The output of the 3D image and dental model engine 302 is provided to a display driver 303 for driving an image display 110. Data from a restorative material physical attributes library 322 and a tooth morphology library 130 may be used by the 3D image and dental model to render a lifelike 3D model of a virtual tooth restoration for display to the user on the image display 110. The display of the lifelike image may include a rendering of the color and translucency of the dentition scanned by the intra oral scanner 102.

The 3D image and dental model engine 302 communicates with a user command processor 304, which accepts user commands generated locally or over the Internet. The user command processor 304 receives commands from a local user through a foot pedal 305, a mouse 306, a keyboard 308, a stylus pad 310, or joystick 311. Additionally, a microphone 312 is provided to capture user voice commands or voice annotations. Sound captured by the microphone 312 is provided to a voice processor 314 for converting voice to text. The output of the voice processor 314 is provided to the user command processor 304. The user command processor 304 is connected to a data storage unit 318 for storing files associated with the digital dental models.

While viewing the 3D representation of the digital dental model, the user may use foot pedal 305, mouse 306, keyboard 308, stylus pad 310, joy stick 311 or voice inputs to control the image display parameters on the image display 110, including, but not limited to, perspective, zoom, feature resolution, brightness and contrast. Regions of the 3D representation of the digital dental model that are highlighted by the dental CAD system as anomalous are assessed by the user and resolved as appropriate. Following the user assessment of the 3D image of the digital dental model, the dental CAD system provides the user with a data compression and encryption engine 320 to process files for secure transmission over the internet.

The dental CAD system 300 also provides the user with tools to perform a variety of treatment planning processes using the digital dental models. Such planning processes include measurement of arch length, measurement of arch width and measurement of individual tooth dimensions. The user may also use the dental CAD system 300 to isolate the tooth being restored from the complete digital dental model and then creates a digital model of just the single tooth. The user may also use the dental CAD system 300 to create a digital model of a group of teeth involved for example with a bridge restoration.

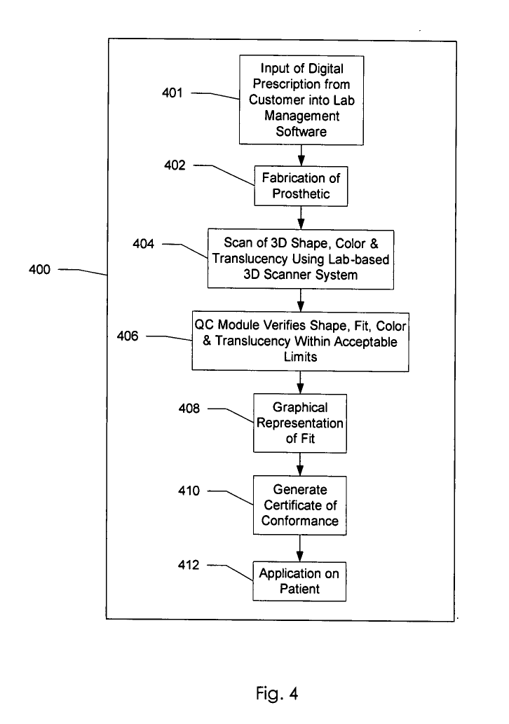

Referring now to FIG. 4, a process 400 shows how the information from the digital prescription is incorporated in the manufacturing process and includes a lab-based version of the 3D QC scanner to verify the end result of manufacturing the prosthetic. Initially, the data is transferred from the digital prescription to the Lab or CAD/CAM system (step 401) via several methods including direct local area network, internet transfer, email, or portable media such as removable disks, CDs, etc. Based on the prescription information, the prosthetic device is generated (step 402). Following completion of the prosthetic, the finished part is scanned on a lab based version of the 3D QC scanner which captures the 3D shape, color and translucency of the finished prosthesis (step 404). A QC software module compares the data from the prosthetic against the digital prescription (step 406). A function within the QC module creates a graphical representation of the fit of the prosthetic based on comparing the QC lab-based scan data with the data provided from the preparation area on the patient (step 408). Areas of the restoration which represent an interference or gap beyond acceptable tolerances can be shown in contrasting colors such as red on a computer rendering module to aid in correction. If the restoration is within predetermined limits a certificate of conformance is issued (step 410). If not within acceptable limits the prosthetic will either be reworked or remade. The finished part is then ready for application on the patient (step 412).

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

By way of example, a block diagram of a computer to support the system is discussed next. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein. While the present invention has been described in connection with certain preferred embodiments, it will be understood that it is not limited to those embodiments. On the contrary, it is intended to cover all alternatives, modifications and equivalents as may be included within the spirit and scope of the invention as defined in the appended claims.

What is claimed is:

1. A system to fabricate a restorative prosthesis for a dentition, comprising:
a. a scanner to capture color and translucency information along with a three dimensional (3D) shape of the dentition being reconstructed; and
b. a 3D image and dental modeling engine module to receive the color and translucency information and the 3D shape to render a color accurate representation of the prosthesis for review, wherein the color, translucency and surface information is combined in a single digital prescription adapted to be electronically transferred to a laboratory or a CAD/CAM system for fabrication.

2. The system of claim 1, wherein the 3D image and dental modeling engine module receives 3D shape of adjacent or occlusal teeth.

3. The system of claim 1, wherein the 3D image and dental modeling engine module receives an original representation of the dentition prior to restoration.

4. The system of claim 1, wherein the 3D image and dental modeling engine module receives a representation of a final exterior surface.

5. The system of claim 1, wherein the scanner captures color by one of: a camera, a spectrophotometer, a hybrid combination thereof.

6. The system of claim 1, wherein the scanner comprises an intra-oral scanner to capture color with a spectrophotometer.

7. The system of claim 1, wherein the scanner comprises a detachable handheld device.

8. The system of claim 1, wherein the scanner captures information relating to translucency and light scattering properties of a tooth.

9. The system of claim 1, wherein the scanner uses detection optics to observe the degree of an illumination beam's light scatter within a semi-transparent tooth structure.

10. The system of claim 9, wherein scattering and resultant line characteristics are quantified to determine the level of translucency of the tooth.

11. The system of claim 1, wherein the scanner scans across the teeth and collects translucency information for a plurality of teeth.

12. The system of claim 11, wherein the translucency information is correlated with the 3D surface structures of the teeth.

13. The system of claim 1, comprising a database of restorative materials from one or more dental manufacturers.

14. The system of claim 13, wherein the database includes construction methodologies with characterized color and translucency characteristics for each material.

15. The system of claim 13, comprising a matching module to automatically select best matching combination of restorative materials.

16. The system of claim 15, wherein the selection of restorative materials is partially guided by a user through a list of parameters.

17. The system of claim 16, wherein the selection of restorative materials is performed totally automatically.

18. The system of claim 13, wherein the user takes an initial color measurement on a tooth before its prepared or on a neighboring tooth and wherein the 3D image and dental modeling engine module selects the best matching material based on material color and translucency characteristics obtained from the database of properties.

19. The system of claim 13, wherein the user mixes a sample of the best matching material and verifies the proper shade and translucency match.

20. The system of claim 1, wherein the combined data set allows for semi-automated or automated selection of materials, thicknesses, colors and tints for a restoration based on a material library.

21. The system of claim 1, wherein the 3D image and dental modeling engine module performs rendering and ray tracing to generate a lifelike computer model of the restoration.

22. The system of claim 21, wherein the computer model includes optical properties of different material compositions, types and shades.

23. The system of claim 22, wherein a final rendered model is lit with simulated light sources to display the restoration under different lighting conditions.

24. The system of claim 23, wherein the simulated light sources and restoration optical properties represent one or more approaches to treatment and help the patient to select a treatment approach to match the patient's budget and aesthetic needs.

25. A system to verify the restorative prosthesis for a dentition, comprising:
a. a scanner to capture color and translucency information along with a three dimensional (3D) shape of the completed prosthesis; and
a 3D image and dental modeling engine module to receive the color and translucency information and the 3D shape to render a color accurate representation of the prosthesis for review, wherein the color, translucency and surface information is compared to a digital prescription containing the 3D shape, color and translucency specifications for the prosthesis.

26. The system of claim 25, wherein the captured data for the color, translucency, and 3D shape of the completed prosthesis is compared against the digital prescription for the prosthesis and a virtual fit check is performed.

27. The system of claim 26, wherein the prosthesis is accepted based upon configurable limits of acceptance with respect to fit tolerances, color match, and translucency match between the prosthesis and the digital prescription.
